(19) United States
(12) Patent Application Publication
(10) Pub. No.: US 2024/0119446 A1
(43) Pub. Date: Apr. 11, 2024

(54) METHODS AND SYSTEMS FOR IDENTIFYING INVALID CERTIFICATES

(71) Applicant: MASTERCARD INTERNATIONAL INCORPORATED, Purchase, NY (US)

(72) Inventors: Rohan Ganpat RANE, Jagdusha Nagar (IN); Swagata CHAKRABORTY, Bhilai (IN)

(21) Appl. No.: 18/377,034

(22) Filed: Oct. 5, 2023

(30) Foreign Application Priority Data
Oct. 7, 2022 (IN) 202241057578

(51) Int. Cl. G06Q 20/38

(52) U.S. Cl. CPC G06Q 20/38215

(57) ABSTRACT

Embodiments provide methods and systems for determining validity of certificates while performing a transaction in a network. A method performed by server system includes receiving a check certificate request message from a plug-in server upon detecting by the plug-in server that a certificate associated with an access control server (authentication server) during a payment transaction is invalid. The check certificate request message includes at least a message reference identifier. The method further includes accessing one or more certificate attributes of the certificate associated with the authentication server based, at least in part, on message reference identifier; determining validity of the certificate associated with the authentication server based, at least in part, on the one or more certificate attributes; and transmitting an update certificate request message to the authentication server based, at least in part, on determining that the certificate associated with the authentication server is invalid.

### TECHNICAL FIELD

The present disclosure relates to secured electronic communication technology and, more particularly, relates to electronic methods and systems for determining the validity of certificates while performing a transaction in a network.

### BACKGROUND

The three domain secure (3DS) or 3D secure is an authentication process that is used to authenticate a cardholder during card-not-present (CNP) transactions such as e-commerce transactions. The 3DS authentication process is used to provide an extra layer of protection to payment card transactions for preventing financial fraud, curtailing unauthorized transactions, and reducing chargebacks. The 3DS authentication process utilizes a Secure Sockets Layer (SSL) protocol to transmit Extensible Markup Language (XML) messages during the authentication process. The three domains of the 3DS include an issuer domain, an interoperability domain, and an acquiring domain. The issuer domain includes issuer banks that deploy an Access Control Server (ACS) for receiving 3DS XML messages to authenticate the cardholder. The acquiring domain includes merchants that deploy a Merchant Plug-in (MPI) platform to initiate a payment transaction. The interoperability domain includes a Directory Server (DS) deployed by a payment processor in a payment network to authenticate and allow communication between the MPI and the ACS. In some global markets such as Europe and India, financial regulators require that all CNP transactions should be authenticated using the 3DS authentication process to ensure maximum security during CNP payment transactions.

It should be understood that due to the widespread implementation of the 3DS authentication process if any fail-point occurs during the payment process, such a scenario would lead to tremendous financial losses along with a huge number of transaction failures. In one such scenario, if an authentication certificate associated with ACS is deemed to be invalid or expired by the MPI during the 3DS authentication process, the payment transaction may be directly dropped or declined by the MPI. To that effect, even if the ACS successfully authenticates the identity of the cardholder, the authorization from the ACS will be rejected by the MPI leading to transaction failure.

Thus, there exists a technological need to overcome the above-stated limitations.

### BRIEF SUMMARY

Various embodiments of the present disclosure provide methods and systems for determining the validity of certificates while performing a payment transaction in a 3DS payment network.

In an embodiment, a computer-implemented method is disclosed. The computer-implemented method performed by a server system includes receiving a check certificate request message from a plug-in server, upon detecting by the plug-in server that a certificate associated with an authentication server during a payment transaction is invalid. The check certificate request message includes at least a message reference identifier. The method further includes accessing one or more certificate attributes of the certificate associated with the authentication server based, at least in part, on the message reference identifier. The method further includes determining validity of the certificate associated with the authentication server based, at least in part, on the one or more certificate attributes. The method further includes transmitting an update certificate request message to the authentication server based, at least in part, on determining that the certificate associated with the authentication server is invalid.

### BRIEF DESCRIPTION OF THE DRAWINGS

For a more complete understanding of embodiments of the present technology, reference is now made to the following descriptions taken in connection with the accompanying drawings in which:

FIG. 1 is an example representation of an environment, related to at least some embodiments of the present disclosure;

FIGS. 2A and 2B, collectively, represent a sequence flow diagram for determining the validity of a certificate while performing a payment transaction in a 3DS payment network, in accordance with an embodiment of the present disclosure;

FIG. 3 represents a sequence flow diagram for updating an authentication certificate associated with the ACS, in accordance with an embodiment of the present disclosure;

FIG. 4 represents a flow chart for determining the validity of a certificate while performing a transaction in a network, in accordance with an embodiment of the present disclosure;

FIG. 5 represents a flow diagram of a computer-implemented method for determining the validity of a certificate while performing a transaction in a network, in accordance with an embodiment of the present disclosure;

FIG. 6 is a simplified block diagram of a server system, in accordance with an embodiment of the present disclosure;

FIG. 7 is a simplified block diagram of a payment server, in accordance with an embodiment of the present disclosure; and

FIG. 8 is a simplified block diagram of a user device, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuer”, used throughout the description, refers to a financial institution normally called an “issuer bank” or “issuing bank” in which an individual or an institution may have an account. The issuer also issues a payment card, such as a credit card or a debit card, etc. Further, the issuer may also facilitate online banking services such as electronic money transfer, bill payment, etc., to the account holders through a server system called “issuer server” throughout the description.

Further, the term “acquirer”, is an organization that transmits a purchase transaction to a payment card system for routing to the issuer of the payment card account in question. Typically, the acquirer has an agreement with merchants, wherein the acquirer receives authorization requests for purchase transactions from the merchants and routes the authorization requests to the issuers of the payment cards being used for the purchase transactions. The terms “acquirer”, “acquiring bank”, “acquiring bank” or “acquirer bank” will be used interchangeably herein. Further, one or more server systems associated with the acquirer are referred to as “acquirer server” to carry out their functions.

The term “payment account”, used throughout the description, refers to a financial account that is used to fund the financial transaction (interchangeably referred to as “payment transaction” or “transaction”). Examples of the payment account include, but are not limited to, a savings account, a credit account, an e-wallet account, a checking account, and a virtual payment account. The payment account may be associated with an entity such as an individual person, a family, a commercial entity, a company, a corporation, a governmental entity, a non-profit organization, and the like. In some scenarios, a payment account may be a virtual or temporary payment account that can be mapped or linked to a primary payment account, such as those accounts managed by payment wallet service providers.

The term “payment network”, used throughout the description, refers to a network or collection of systems used for the transfer of funds through the use of cash substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be operated to perform transactions via cash substitutes, which may include payment cards, letters of credit, checks, financial accounts, etc. One example of a payment network includes those operated by Mastercard®.

The term “payment card”, used throughout the description, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards, and stored-value cards. A payment card may be a physical card that may be presented to the merchant for funding the payment. Alternatively, or additionally, the payment card may be embodied in form of data (e.g., a digital token) stored in a user device, where the data is associated with the payment account such that the data can be used to process the financial transaction between the payment account and a merchant's financial account.

The term “merchant”, used throughout the description, may include a merchant that has a relationship with the payment processing network. The merchant may receive the proceeds from a purchase when the purchase is settled. The merchant is the company that is ultimately responsible for the financial transaction.

The terms “three domain secure”, “3D secure” or “3DS” interchangeably used through the description, refer to an authentication process used to authenticate a cardholder during card-not-present (CNP) transactions such as e-commerce transactions. The three domains of the 3DS authentication process include the issuer domain, the interoperability domain, and the acquiring domain. The issuer domain includes issuer banks that deploy an Access Control Server (ACS) for receiving 3D secure XML messages to authenticate the cardholder. The acquiring domain includes the merchants that deploy a Merchant Plug-in (MPI) to initiate a payment transaction. The interoperability domain includes a Directory Server (DS) deployed by a payment processor in a payment network to authenticate and allow communication between the MPI and the ACS.

The term “3DS program” or “3DS service” interchangeably used through the description, refers to the optional service provided to a cardholder by his/her issuer through which the cardholder may engage in CNP payment transactions with the 3DS authentication process. In various non-limiting examples, the cardholder may be required to voluntarily enroll in the 3DS program or a regulating entity may mandate the 3DS service for all payment transactions. Further, the term “3DS payment network” refers to a payment network or architecture within which payment transactions are authenticated using the 3DS authentication process.

The term “merchant application”, used throughout the description, may be associated with a particular merchant or may be associated with a number of different merchants and may be capable of identifying a particular merchant (or multiple merchants) which are parties to a transaction. For instance, the merchant application may store information identifying a particular merchant server computer that is configured to provide a purchase environment in which the merchant server computer is capable of processing remote transactions initiated by the merchant application. Further, the merchant application may also include a general-purpose browser or other software-designed application to interact with multiple merchant server computers as long as the browser is configured to identify the merchant server computer and process a remote transaction. The merchant application may be installed on the general-purpose memory of a mobile device.

The term “payment service provider”, may include an entity that contracts with an acquirer for the purpose of providing acceptance to a sponsored merchant, the sponsored merchant then contracts with a payment service provider to obtain payment services.

### OVERVIEW

Various embodiments of the present disclosure provide methods, systems, user devices, and computer program products for determining the validity of a certificate associated with the authentication server in a network. Thereby, enabling the authentication server to update its certificate as soon as the same expires or becomes invalid. To that end, the authentication server may update its certificate(s) and therefore prevent future transactions from being dropped by the plug-in server. The present disclosure provides a system that can determine the validity of certificates while performing a transaction (or a communication exchange) in the network and request the entity with an expired or invalid certificate to renew their certificates upon detection. It should be understood that for the purpose of explanation, the authentication server is assumed to be an access control server (ACS and the plug-in server is assumed to be a merchant plug-in (MPI) server. It should be noted that although various exemplary embodiments of the present disclosure are described herein with reference to payment transactions in a 3DS payment network, the various embodiments of the present disclosure are applicable in other suitable networks as well.

To that end, the present disclosure describes a server system that is configured to determine the validity of a certificate associated with the ACS and request the ACS to generate a new certificate upon detecting an invalid certificate. In an embodiment, the server system is a directory server, i.e., a part of a payment network. In another embodiment, the server system is configured to receive a check certificate request message from the MPI server. In a non-limiting example, the check certificate request message includes at least a message reference identifier. In an embodiment, the MPI server may transmit the check certificate request message upon detecting that a certificate associated with an access control server (ACS) during a payment transaction is invalid.

In an embodiment, the server system is configured to access one or more certificate attributes of the certificate associated with the ACS based, at least in part, on the message reference identifier. In a non-limiting example, the one or more certificate attributes may include at least a certificate identifier, a certificate expiry date (OR certificate validity period), a certificate version, and certificate issuer information.

In an embodiment, the server system is configured to determine the validity of the certificate associated with the ACS based on the one or more certificate attributes. In an example, whether the certificate validity period associated with the certificate has expired is determined based at least on the certificate validity period.

In an embodiment, the server system is configured to transmit an update certificate request message to the ACS based, at least in part, on determining that the certificate associated with the ACS is invalid. Further, the server system is configured to receive an update certificate acknowledgment message from the ACS in response to the update certificate request message.

In an embodiment, the server system is configured to transmit a check certificate response message to the MPI server. In a non-limiting example, the check certificate response message may include a valid flag based, at least in part, on determining that the certificate associated with the ACS is invalid. In an alternative non-limiting example, the check certificate response message may include an invalid flag based, at least in part, on determining that the certificate associated with the ACS is valid.

In an embodiment, the server system is configured to transmit an update ACS certificate advice message to the issuer server associated with the ACS. In another embodiment, the server system is configured to receive an acknowledgment message from the issuer server.

In an embodiment, the server system is configured to receive an updated ACS certificate from the ACS server. The updated ACS certificate may include one or more new certificate attributes. Further, the server system is configured to update the one or more certificate attributes with the one or more new certificate attributes.

Various embodiments of the present disclosure offer multiple technical advantages and technical effects. For instance, the present disclosure helps in reducing the transaction failure rate in CNP payment transactions that occur due to invalid/expired certificates. Further, the present disclosure informs every entity involved in the CNP payment transaction that a certificate associated with the ACS has expired. This enables the ACS to promptly renew or reissue its certificates thereby reducing ACS downtime and financial losses due to transaction failure. Further, by informing every entity in the payment network regarding the invalid/expired certificate, the likelihood of corrective action being performed by either the ACS or the issuer increases.

The technical improvement in the 3DS-enabled payment network as described herein is a computer-based solution to a technical deficiency or problem that is itself rooted in computer technology (e.g., the problem itself derives from the use of computer technology). More specifically, an MPI dropping a payment transaction due to an invalid certificate of the ACS is a significant problem for CNP transactions conducted over an electronic payment network. Therefore, the present disclosure provides a system that can determine the validity of certificates while performing a payment transaction in the 3DS payment network and request the entity with an expired or invalid certificate to renew their certificates upon detection.

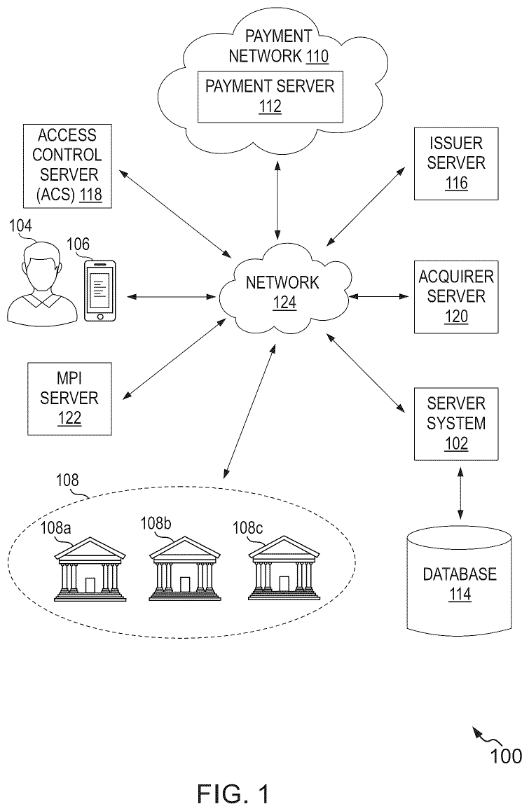

Various embodiments of the present disclosure are described hereinafter with reference to FIGS. 1 to 8.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, determining the validity of a certificate associated with the ACS in a 3DS payment network. The environment 100 generally includes a server system 102 associated with a database 114, a user device 106 associated with a cardholder 104, a plurality of merchants 108a, 108b, and 108c (collectively represented as merchant 108), a payment network 110 including a payment server 112, an issuer server 116, an access control server 118 (referred hereafter as ‘ACS’), an acquirer server 120, and a merchant plug-in server 122 (referred hereafter as interchangeably as ‘MPI server 122’ or ‘MPI 122’) each coupled to, and in communication with a network 124. The network 124 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among two or more of the parts illustrated in FIG. 1, or any combination thereof.

Various entities in the environment 100 may connect to the network 124 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 124 may include multiple different networks, such as a private network made accessible by the server system 102 and a public network (e.g., the Internet, etc.) through which the server system 102, the payment server 112, the plurality of merchants 108a-108c, the issuer server 116, the ACS 118, acquirer server 120, MPI 122, and the user device 106 may communicate.

In one embodiment, the cardholder 104 may be an individual, representative of a corporate entity, non-profit organization, or any other person. Examples of the user device 106 associated with the cardholder 104 may include, without limitation, a smartphone, tablet computers, other handheld computers, wearable devices, servers, portable media players, gaming devices, and so forth. In an embodiment, the desktop device may be installed with an internet browser application that may be used by a cardholder 104 for performing payment transactions associated with the merchant 108 over the internet. In another embodiment, the user device 106 may be installed with an application or an ‘app’ such as but not limited to a merchant application that is configured to integrate various APIs for performing payment transactions associated with the merchant 108a via the internet. As it may be understood, the term “application” is used broadly to include any software program(s) capable of implementing the features described herein.

In various examples, the application may include any internet browser, API, service, application, applet, or other executable code suitable to retrieve payment information from a secure element, generate payment information (e.g., a dynamic value, etc.) for a payment transaction, and communicate with a server system application, merchant application, mobile gateway, and/or any other application in order to securely communicate with a server computer (e.g., remote key manager, mobile gateway, payment processing network, third-party service provider, 3DS payment network, etc.). Further, the application may be configured to obtain stored information including user private key, payment credentials, third party keys, and mobile gateway credentials, and may be capable of communicating with an issuer to obtain issuer updates.

In some examples, the cardholder 104 may operate the user device 106 to conduct a payment transaction through a payment gateway application, i.e., a CNP transaction. The cardholder 104 may have established a card-on-file relationship with a merchant (e.g., merchant 108a). It should be understood that the cardholder 104 is enrolled in the 3DS service offered by the payment processor associated with the issuer bank of the cardholder 104. Further, it should be understood that the 3DS service may be offered by various payment processors under different names while the underlying technology and architecture generally remain the same. For example, 3DS services offered by payment processors include Mastercard SecureCode® (offered by Mastercard®), Verified by Visa® (offered by Visa®), J/Secure® (offered by JCB International®), American Express SafeKey® (offered by American Express®) or the like.

In one embodiment, the issuer server 116 is a financial institution that manages cardholder accounts (i.e., payment accounts) of multiple cardholders. Payment account details of the payment accounts established with the issuer server 116 are stored in cardholder profiles of the cardholder 104 in memory of the issuer server 116 or on a cloud server associated with the issuer server 116. The issuer server 116 approves or denies an authorization request, and then routes, via the payment network 110, an authorization response back to the acquirer server 120. The acquirer server 120 sends the approval to the merchant 108a. The payment account details may include an account balance, an available credit line, account holder details, transaction history of the cardholder 104, account information, or the like. The details of the cardholder 104 may include name, age, gender, physical attributes, registered contact number, alternate contact number, registered e-mail ID, and the like. The cardholder account may be associated with one or more payment means that enable the cardholder 104 to facilitate the payment transaction.

Examples of one or more payment means may include, payment cards, Unified Payment Interface (UPI) links, and/or the like. Methods for processing transactions via the issuer server 116 will be apparent to a person of ordinary skill in the art and may include processing the transactions via the traditional four-party system. The terms “issuer server”, “issuer”, or “issuing bank” will be used interchangeably herein.

In one embodiment, the ACS 118 is associated with the issuer 116 and authenticates the cardholder 104 during CNP transactions such as e-commerce transactions in the 3DS payment network. The ACS 118 is responsible for facilitating and supporting cardholder authentication. In an embodiment, the ACS 118 is maintained by the issuer 116 of the cardholder 104. The ACS 118 authenticates the cardholder 104 by performing various authentication processes such as, but not limited to, requiring a username and password from the cardholder 104 to authenticate a payment transaction, performing two-factor authentication (2FA) (by requiring a One-Time Password (OTP) from the cardholder 104). In an embodiment, the ACS 118 may be associated with an authentication certificate (referred hereafter as ‘certificate’) that is essential for determining the authenticity of the ACS 118 within the 3DS payment network by various entities such as the server system 102, issuer 116, and the MPI 122. In one example, the certificate associated with the ACS is an extensible markup language (XML) certificate. In various examples, the certificate may be generated by one of the ACS 118, the issuer 116, the payment processor, the server system 102, or a certificate authority (CA). The certificate includes at least one or more certificate attributes. Further, the one or more certificate attributes may include at least a certificate identifier, a certificate expiry date (i.e., certificate validity period), a certificate version, certificate issuer information, etc., among other suitable attributes. It should be understood that each certificate issued to the ACS 118 is issued for a limited time period for ensuring security in the 3DS authentication process. Therefore, certificates have limited validity, and once the validity period expires, the certificate becomes invalid. In various non-limiting examples, the certificate may be valid for time periods such as six months, one year, one and a half years, two years, and so on based on the security requirements of the 3DS payment network.

In one embodiment, the acquirer server 120 is associated with a financial institution (e.g., a bank) that processes financial transactions. This can be an institution that facilitates the processing of payment transactions for physical stores, ATM terminals, merchants 108a-108c, or an institution that owns platforms that make online purchases or purchases made via software applications possible (e.g., shopping cart platform providers and in-app payment processing providers). The terms “acquirer”, “acquirer bank”, “acquiring bank” or “acquirer server” will be used interchangeably herein.

In one embodiment, the MPI server 122 is a financial platform that integrates merchants (such as merchant 108a-108c) with the 3DS payment network. The MPI server 122 can be a platform that allows the cardholder 104 to initiate a payment transaction by sharing their payment card details with the merchant's 3DS-enabled application or website. It should be understood that in various non-limiting examples, the MPI server 122 may be a software-enabled platform or a software-based module that integrates with the merchant website or application through an API or other suitable integration techniques. The MPI software module may be associated with the acquirer server 120 to facilitate the payment transaction process. The terms “MPI”, “MPI platform” or MPI server” will be used interchangeably herein.

In one embodiment, the plurality of merchants 108a, 108b, and 108c represents authorized accepters of payment cards for the payments for goods/services sold by the plurality of merchants 108a-108c. In one embodiment, the merchant (any one of 108a, 108b, and 108c) is associated with an acquirer server 120. In another embodiment, the merchant (any one of 108a, 108b, and 108c) is associated with the MPI server 122. Further, the plurality of merchants 108a-108c may accept payments through the 3DS program.

In one embodiment, the server system 102 is configured to perform one or more operations described herein. In another embodiment, the server system 102 is configured to authenticate and allow communication between the MPI server 122 and the ACS 118. Therefore, the server system 102 authenticates and validates the various 3DS requests within the 3DS payment network. In a non-limiting example, the server system 102 may be a directory server (DS) in the interoperability domain of the 3DS payment network, and the server system 102 may be associated with the payment network 110. In one example, the server system 102 is coupled with a database (such as database 114). Further, the server system 102 may store various data elements associated with the various entities in the environment 100. In various examples, the data elements may include at least authentication certificates of various entities, cardholder details, issuer information, ACS information, MPI information, acquirer information, etc., among other suitable data elements. In an embodiment, the server system 102 is further configured to store one or more certificate attributes of the certificate associated with the ACS 118 when the ACS 118 is initialized in the 3DS payment network.

In a non-limiting example, to initiate a payment transaction, the cardholder (i.e., cardholder 104) may open a merchant application operated by the merchant 108a on the user device 106 and initiate the transaction with the merchant 108a. The cardholder 104 may enter payment card information or the user device 106 reads already stored payment card information. The merchant may request the MPI server 122 associated with the merchant 180a to determine whether the cardholder is enrolled in the 3DS program. Thereafter, the MPI server 122 generates a verification request (Vreq) message and shares the Vreq message with the Directory server (DS) (i.e., the server system 102) to confirm whether the cardholder 104 is enrolled in the 3DS program. The DS responds to the MPI server 122 with the verification response (Vres) message to share the enrollment status of the cardholder 104. In a scenario, where the cardholder 104 is enrolled in the 3DS program, the Vres message includes an ACS URL to identify a specific ACS (such as ACS 118) for MPI server 122 to communicate with and authenticate the cardholder 104. Then, the MPI server 122 initiates the payment authorization process by generating and sharing a payer authorization request (Pareq) message with the ACS 118. Further, the ACS 118 performs the authentication process. In one example, during the authentication process, the ACS 118 generates an OTP (One-time Password) and shares it with the cardholder 104. The cardholder device 104 receives an OTP on their user device 106. Then, the cardholder 104 enters the OTP on a webpage such as a payment gateway associated with the merchant application to proceed with the payment transaction. The payer authorization request message typically includes the payment card number, primary account number (PAN), the amount of the transaction, and other information, such as merchant identification and location. Upon the completion of the authorization process, the issuer server 116 settles the payment with the acquirer server 120.

In an exemplary scenario, if the certificate associated with the ACS 118 is invalid or expired, the MPI server 122 will drop the payment transaction even if the cardholder 104 is authenticated and the payment transaction is authorized. It should be understood that the MPI server 122 will treat the ACS 118 with an expired certificate as an untrusted party thereby, it will not trust any messages from the ACS 118 even if the ACS 118 is genuine. However, it is pertinent to note that there exists no mechanism for determining by either the merchant, acquirer, payment processor, or the issuer the reason due to which the MPI server 122 has dropped the payment transaction. Further, there exists no solution for rectifying this deficiency. Such a scenario would lead to tremendous financial losses and payment transaction failures if this issue is not promptly resolved.

Thus, there is a technical need for a system that can determine the validity of certificates while performing a payment transaction in the 3DS payment network and request the entity with an expired or invalid certificate to renew its certificates upon detection.

In one embodiment, the server system 102 is configured to perform one or more operations described herein. In one example, the server system 102 is configured to determine the validity of the certificate associated with the ACS 118. The server system 102 is configured in a manner (described in connection with the next set of figures) that facilitates transmission of an update certificate request message to the ACS 118 if the certificate associated with the ACS 118 is invalid. The determination process may be initiated by the server system 102 upon receiving a check certificate request message from the MPI server 122. In an embodiment, the check certificate request message is generated by the MPI server 122 upon detecting by the MPI server 122 that a certificate associated with the ACS 118 during a payment transaction is invalid. In an example, the check certificate request message includes at least a message reference identifier among other transaction related information.

It should be understood that the server system 102 is a separate part of the environment 100, and may operate apart from (but still in communication with, for example, via the network 124) the payment server 112, the MPI server 122, the ACS 118, the issuer server 116, the acquirer server 120, and any third party external servers (to access data to perform the various operations described herein). However, in other embodiments, the server system 102 may actually be incorporated, in whole or in part, into one or more parts of the environment 100, for example, the payment server 112, the issuer server 116, the ACS 118, the MPI server 122, or the acquirer server 120. In addition, the server system 102 should be understood to be embodied in at least one computing device in communication with the network 124, which may be specifically configured, via executable instructions, to perform as described herein, and/or embodied in at least one non-transitory computer-readable media.

In one embodiment, the server system 102 is connected with the database 114. The database 114 is configured to store one or more certificate attributes associated with the authorization certificates of the various entities involved in the 3DS payment network such as the ACS 118 and the MPI 122. It should be understood that the one or more certificate attributes are received from the various entities involved in the 3DS payment network during their initiation or initialization. For example, when a new ACS is initialized by the issuer, the ACS may generate an authorization certificate and share the attributes associated with the server system 102 (such as the DS) to be stored in the database 114.

In one embodiment, the payment network 110 may be used by the payment card issuing authorities as a payment interchange network. The payment network 110 may include a plurality of payment servers such as the payment server 112. Examples of payment interchange networks include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

Further, it should be noted that the various embodiments of the present disclosure are applicable to any version of the 3DS authentication process including but not limited to 3DS 1.0, 3DS 2.0, or any other future version. However, this should not be construed to be a limitation and the approach of the present disclosure may be implemented in other authentication processes as well.

The number and arrangement of systems, devices, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

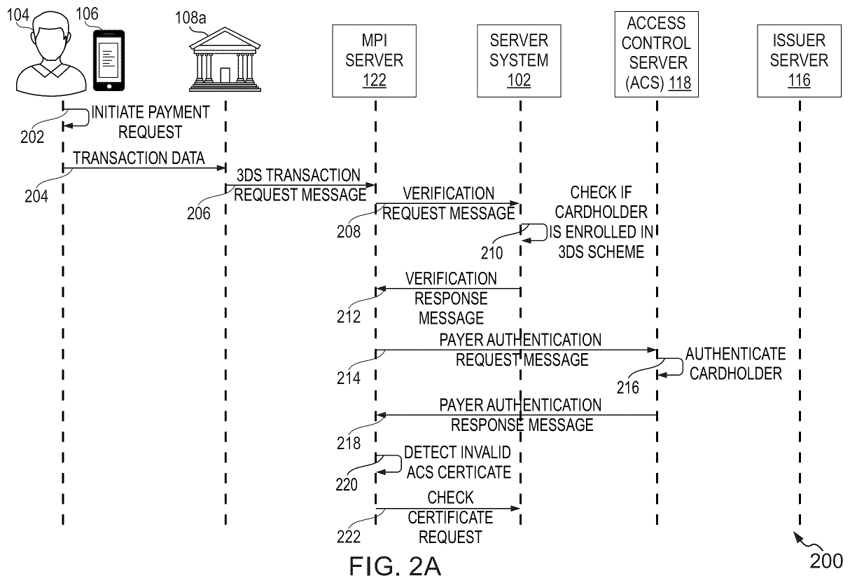

FIGS. 2A and 2B, collectively, represent a sequence flow diagram 200 for determining the validity of a certificate while performing a payment transaction in a 3DS payment network. The sequence of operations of the sequence flow diagram 200 may not be necessarily executed in the same order as they are presented. Further, one or more operations may be grouped together and performed in the form of a single step, or one operation may have several sub-steps that may be performed in parallel or in a sequential manner.

At 202, the cardholder 104 initiates an online payment transaction on an application associated with a merchant 108a accessible on the user device 106. In an embodiment, the application may be any application that can be a mobile or desktop application and can be used to access a merchant website, third-party websites, or an application with an application programming interface (API) provided by the merchant 108a. The cardholder 104 may use the merchant application to purchase goods or services from a remote location. In an example, the cardholder 104 may select one or more products and/or services offered by the merchant 108a for purchase on the application. The cardholder 104 may then initiate the payment transaction by pressing, for example, “pay”, “checkout” or “proceed to pay” on a user interface of the application.

At 204, after submitting the card details the user device 106 of the cardholder 104, the user device 106 sends transaction data to the merchant 108a. In an embodiment, the transaction data may include at least a user identifier, payment card data, a transaction amount, product data, purchase data, etc., among other transaction specific data. In one example, the transaction data is sent to the merchant 108a for enabling the merchant to determine which goods or services the cardholder 104 intends to purchase. Further, the transaction data enables the merchant 108a to determine the payment card details of the cardholder 104 along with other cardholder-related information such as cardholder's issuer, payment processor or the like.

At 206, the merchant 108a sends a 3DS transaction request message to the MPI server 122. It should be understood that for performing the payment transaction with enhanced security, the merchant 108a may opt to proceed the transaction with 3DS payment network. In an example, the merchant 108a may opt to proceed using the 3DS payment network to comply with regulations. It should be understood that using a 3DS authentication process for authenticating and authorizing transactions reduces the overall risk associated with the CNP transactions, i.e., the risk of fraud may be mitigated significantly. Therefore, the merchant 108a may opt to proceed using the 3DS authentication process by generating and sending the 3DS transaction request message with the MPI server 122. In one example, the 3DS transaction request message may be an XML script.

At 208, the MPI server 122 sends a verification request (Vreq) message to the server system 102. In an embodiment, upon receiving the 3DS transaction request message to process the transaction, the MPI server 122 determines whether the cardholder is enrolled in the 3DS program or not. To that end, the MPI server 122 generates a Vreq message and shares it with the server system 102. In one example, the Vreq message may be an XML script that includes various parameters such as but not limited to message reference identifier (hereafter referred to interchangeably as ‘message ID’), version details, primary account number (PAN), acquirer bank identification number (BIN), merchant identifier (Merchant ID), etc., among other suitable parameters.

An example pseudo-code for the XML script for verifying whether the cardholder is enrolled in the 3DS program or not, i.e., XML script for Vreq message is given below:

<?xml version=“1.0” encoding=“UTF-8” standalone=“no”?>
<ThreeDSecure>
<Message id=“21460000000046998903”>
<VEReq>
<version>1.0.2</version>
<pan>510372** ***6399</pan>
<Merchant>
<acqBIN>2XX112</acqBIN>
<merID>107XXXX004037 9</merID>
</Merchant>
</VEReq>
</Message>
</ThreeDSecure>

At 210, the server system 102 determines whether the cardholder 104 is enrolled in the 3DS program. In an embodiment, the server system 102 determines whether the cardholder is enrolled in the 3DS program based on pre-stored data in the database (such as database 114). In one example, the server system 102 may utilize the PAN data from the Vreq message to determine whether the cardholder 104 is enrolled in the 3DS program or not. For example, the server system 102 may search the database for cardholder details using the PAN data. Herein, it is assumed that the server system 102 maintains a list of the cardholders enrolled in the 3DS program within the database 114. In an alternative embodiment, the server system 102 may communicate with the ACS 118 to determine whether the cardholder is enrolled in the 3DS program or not. The ACS 118 may further communicate with the issuer 116 to determine the enrollment status of the cardholder 104 and share the results with the server system 102.

At 212, the server system 102 sends a verification response (Vres) message to the MPI server 122. In an embodiment, upon determining by the server system 102 whether the cardholder 104 is enrolled the 3DS program or not, the server system 102 generates a Vres message. In various examples, the Vres message may be an XML script that includes at least enrollment status (result of the enrollment check), acctID (masked string used by the ACS 118), uniform resource locator (URL) of the ACS 118, etc., among other suitable parameters.

In an embodiment, if it is determined that the cardholder 104 is not enrolled in the 3DS program, the Vres message may share a ‘not enrolled’ flag with the MPI server 122. In an example, the enrollment status may be set using the value ‘N’ (when cardholder 104 is not participating in 3DS program) or ‘U’ (when the server system 102 is unable to determine the enrollment status due to any number of reasons) in the ‘enrolled’ field. Further, parameters such as the acctID and the URL may be set to ‘NULL’ when the cardholder 104 is not enrolled in the 3DS program.

In an alternative embodiment, if it is determined that the cardholder 104 is enrolled in the 3DS program, the Vres message may share an ‘enrolled’ flag with the MPI server 122. In an example, the enrollment status may be set using the value ‘Y’ when cardholder is participating in 3DS program in the ‘enrolled’ field. Further, parameters such as the acctID and the URL are set appropriately by the server system 102.

An example pseudo-code for the XML script for Vres message is given below:

<?xml version=“1.0” encoding=“UTF-8”?>
<ThreeDSecure>
<Message id=“21460000000046998903”>
<VERes>
<version>1.0.2</version>
<CH>
<enrolled>Y</enrolled>
<acctID>102175094899166875182738</acctID>
</CH>
<url>https://acs2.onlXXXXbi.com/bdacs/XXXXalidate/M</url>
<protocol>ThreeDSecure</protocol>
</VERes>
</Message>
</ThreeDSecure>

At 214, the MPI server 122 sends a payer authorization request (Pareq) message to the ACS 118. In an embodiment, upon determining that the cardholder is enrolled in the 3DS program, the MPI server 122 generates and sends the Pareq message with the ACS 118. In an example, the Pareq message may be referred as the message used by the MPI 122 to request the ACS 118 for authorizing a payer during a payment transaction. In various examples, the Pareq message may be an XML script that includes at least merchant ID, acquirer BIN, merchant name, country name/code, merchant URL, unique transaction identifier (XID), date and time of transaction request, payment amount for the payment transaction, expiry details of cardholder's payment card, acctID, etc., among other suitable parameters.

An example pseudo-code for the XML script for Pareq message is given below:

<?xml version=“1.0” encoding=“UTF-8”?>
<ThreeDSecure>
<Message id=“21460000000046998903”>
<PAReq>
<version>1.0.2</version>
<Merchant>
<acqBIN>2XX112</acqBIN>
<merID>107XXXX00403769</merID>
<name>ABC TECHNOLOGY</name>
<country>356</country>
<url>https://www.caXXXXe.com</url>
</Merchant>
<Purchase>
<xid>MjE0NjAwMDAwMDAwNDY5OTg5MDM=</xid>
<date>20220526 15:23:02</date>
<amount>Rs.50.00</amount>
<purchAmount>5000</purchAmount>
<currency>356</currency>
<exponent>2</exponent>
</Purchase>
<CH>
<acctID>102175094899166875182738</acctID>
<expiry>2207</expiry>
</CH>
</PAReq>
</Message>
</ThreeDSecure>

At 216, the ACS 118 performs cardholder authentication. In an example, the cardholder authentication process may be done using two-factor authentication (2FA). In an example, during the 2FA authentication, the ACS 118 generates an OTP (One-time Password) and shares it with the cardholder 104. The user device 106 of the cardholder 104 receives an OTP and then the cardholder 104 enters the OTP on a webpage such as a payment gateway associated with the merchant application to proceed with the payment transaction. In various examples, other authentication processes may also be used by the ACS 118 to perform the cardholder authentication.

At 218, the ACS 118 sends a payer authorization response (Pares) message to the MPI server 122. In an embodiment, the Pares message is used by the ACS 118 to inform the status of the cardholder authentication process to the MPI server 122. In various examples, the Pares message may be an XML script that includes at least merchant ID, message reference ID (message ID), acquirer BIN, unique transaction identifier (XID), date and time of transaction request, payment amount for the payment transaction, PAN details, authorization date (AuthDate), authentication status, cardholder authentication verification value (CAVV or AVV), electronic commerce indicator (ECI), etc., among other suitable parameters.

In an embodiment, if the cardholder authentication has failed, the Pares message may share an ‘unsuccessful’ flag with the MPI 122. In an example, the authentication status may be set using any of the value ‘N’ (cardholder fails authentication) or ‘U’ (when the server system 102 is unable to complete the authentication due to any number of reasons) or ‘A’ (when authentication attempt was generated) in the ‘status’ field.

In an alternative embodiment, if the cardholder 104 is successfully authenticated by the ACS 118, the Pares message may share a ‘successful’ flag with the MPI 122. In an example, the authentication status may be set using the value ‘Y’ in the ‘status’ field when cardholder 104 is successfully authenticated. In one example, the Pares message is encrypted before it is transmitted to the MPI server 122.

An example pseudo-code for the XML script for a decrypted Pares message is given below:

{
MID :107XXXX00403769
TID :10381832
Request ID :978000613
Message ID :21460000000046998903
Rsp Code :00
Error Desc :00 - Success
Algo :3
ECI :02
Auth Status :Y
UCAF :****************************
CAVV :
XID : MjE0NjAwMDAwMDAwNDY5OTg5MDM=
Amount :000000005000
Currency Code:356
}

At 220, the MPI server 122 determines that the certificate associated with the ACS 118 is invalid. In an embodiment, upon receiving the Pares message, the MPI server 122 determines whether the identity of the ACS 118 sending the Pares message is genuine or fraud. In an example, the MPI server 122 may validate the identity of the ACS 118 based on pre-stored key certificate attributes. It should be understood that during the initialization of a new ACS in the 3DS payment network, the directory server (i.e., the server system 102) shares one or more key certificate attributes with the plurality of different MPI servers associated with the plurality of merchants 108. In various non-limiting examples, the one or more key certificate attributes may include a certificate identifier, an ACS identifier (such as acctID), a certificate validity period and the like. In a scenario, if the MPI server 122 determines that the validity period of the certificate associated with the ACS 118 from which Pares message is received is invalid, then the MPI server 122 may label the ACS 118 as untrustworthy and drop the payment transaction.

At 222, the MPI server 122 sends a check certificate request message to the server system 102. In an embodiment, upon dropping the payment transaction due to an invalid certificate, the MPI server 122 generates the check certificate message. In an example, the check certificate message may include at least a message reference identifier, i.e., message ID. It should be understood that the message ID is a unique identifier that remains the same for a given payment transaction. The message ID is generally located within the XML header of the 3DS XML script. It should be understood that since the message ID remains identical during the payment process, therefore any entity in the payment network 110 can identify a payment transaction using its message ID.

An example pseudo-code for the XML header in the 3DS XML script is given below:

<?xml version=“1.0” encoding=“UTF-8”?>
<ThreeDSecure>
<Message id=“21460000000046998903”>
</Message>
</ThreeDSecure>

At 224, the server system 102 accesses one or more certificate attributes of the certificate associated with the ACS 118. In an embodiment, upon receiving the check certificate message, the server system 102 may at first locate information related to the relevant payment transaction and the ACS 118 used for authenticating the cardholder 104 during the relevant payment transaction from a database (such as database 114) associated with the server system 102. In one example, the server system 102 relies on the message ID included in the check certificate message, to determine the relevant payment transaction and the ACS 118. It should be understood that when a new ACS is initialized by the issuer, all relevant details regarding the new ACS are shared with the directory server (i.e., the server system 102). In non-limiting examples, these relevant details may be stored in lists or arrays by the server system 102 in an internal or external database. Further, in an example, the relevant details may include at least one or more certificate attributes of the certificate associated with the new ACS such as but not limited to a certificate identifier, a certificate validity period, a certificate version, certificate issuer information, etc., among other suitable details. Therefore, it should be understood that the server system 102 can determine and accesses the one or more certificate attributes of the certificate associated with the ACS 118 based on the message ID by performing a lookup operation in the database.

At 226, the server system 102 determines the validity of the certificate. In an embodiment, upon accessing the one or more certificate attributes of the certificate associated with the ACS 118, the server system 102 may check validity of the certificate. In an example, the server system 102 may utilize the certificate validity period attribute for determining whether the certificate is valid or invalid/expired. It should be understood that if the certificate validity is expired, the certificate is deemed to be invalid and alternatively if the certificate validity has not expired, the certificate is deemed to be valid by the server system 102.

At 228, upon determining the validity of the certificate, the server system 102 sends a check certificate response message with the MPI server 122. In an embodiment, in response to detecting a valid certificate, the server system 102 generates and sends the check certificate response message to the MPI server 122 with a result flag. In an example, the check certificate response message with an invalid result flag may inform the MPI 122 that the certificate associated with the ACS 118 is valid. Therefore, this message is used to inform the MPI server 122 that its detection is incorrect. In one example, the check certificate response message with the invalid result flag may prompt the MPI server 122 to conduct an internal diagnosis for identifying any security compromises or compromised databases. For example, the MPI server 122 may check the MPI database for possible tampering among other possible signs of any malicious activities. Therefore, the check certificate response message may enable the MPI server 122 to detect any irregularities in its database due to either mismanagement or a malicious entity (such as a hacker). In an embodiment, upon sending the check certificate response message with a valid certificate flag, the sequence flow may conclude.

Alternatively, in response to detecting an invalid certificate, the server system 102 generates and sends the check certificate response message to the MPI server 122 with a valid result flag. In an example, the certificate invalid response message may inform the MPI 122 that the certificate associated with the ACS 118 is indeed invalid. The process flow moves to operation 230.

At 230, upon determining that the certificate is invalid, the server system 102 sends an update certificate request message with the ACS 118. In an embodiment, the update certificate request message informs the ACS 118 that the certificate associated with it has expired. It should be understood that upon learning that its certificate has expired, the ACS 118 may promptly proceed to renew or reissue its certificates thereby reducing ACS 118 downtime and financial losses.

At 232, upon determining that the certificate is invalid, the server system 102 also sends an update ACS certificate advice message with the issuer 116. In an example, the update ACS 118 certificate advice message is a 0120 Message Type Indicator (MTI) request message. For example, a 120 MTI request message may include the code ‘DE48.SE42.SF1 612’ to advise the issuer 116 that the certificate has expired. Here, 6 stands for certificate expired at Position 1 (Security Protocol) of subfield 1.

In an embodiment, the update ACS certificate advice message informs the issuer 116 that the certificate associated with the ACS 118 has expired. Further, the ACS certificate advice message informs the issuer 116 that any payment transactions directed towards the ACS 118 with the expired certificate for authentication will fail. Therefore, the issuer server 116 may redirect future payment transactions towards a different or new ACS in order to prevent transaction failures until the ACS renews its certificates.

It should be understood that by informing both the ACS 118 and issuer 116 regarding the expired certificate, the approach of the present disclosure increases the likelihood of corrective action by either the ACS 118 or the issuer 116, and this aspect of the present disclosure ensures reduced ACS 118 downtime and transaction failures. Further, by sending the update certificate request message and the update ACS certificate advice message for each and every transaction dropped by the MPI server 122 due to an expired certificate, the probability of these messages being missed by both the ACS 118 and issuer 116 respectively is significantly reduced.

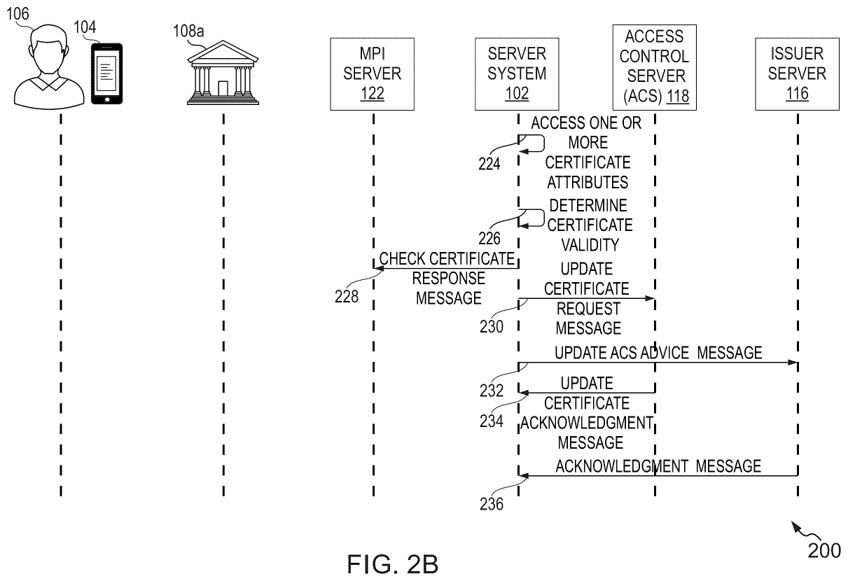

At 234, the ACS 118 sends an update certificate acknowledgement message to the server system 102. This aspect has been explained further in reference with FIG. 3 later in the present disclosure.

At 236, the issuer sends an acknowledgment message to the server system 102. In an example, the acknowledgement message is a 0130 Message Type Indicator (MTI) response message. For example, the DE field of the 0130 MTI response message may be set to 00 (DE39=00) to inform the server system 102 that the issuer 116 has acknowledged the update ACS certificate advice message.

FIG. 3 represents a sequence flow diagram 300 for updating an authentication certificate associated with the ACS 118, in accordance with an embodiment of the present disclosure. The sequence of operations of the sequence flow diagram 300 may not be necessarily executed in the same order as they are presented. Further, one or more operations may be grouped together and performed in the form of a single step, or one operation may have several sub-steps that may be performed in parallel or in a sequential manner. The sequence flow diagram 300 explains the process of updating an authentication certificate associated with the ACS 118. The sequence flow starts at 302.

At 302, the server system 102 sends an update certificate request message to the ACS 118. It should be noted that operation 302 is analogous to operation 230 described with reference to FIG. 2B. Therefore, it is not explained here again for the sake of brevity.

In an example, the update certificate request message may include at least a certificate identifier (certificate ID), the message reference ID, a common name (CN), organization unit (OU) identifier, expiry date (such as, certificate expiry date), action flag, etc., among other suitable parameters. The CN parameter is populated with one of the characteristics of the merchant or MPI 122 (i.e., the requestor for the certificate) that will utilize the certificate [Domain Name] OR [public IP]. It should be understood that the CN parameter can be used by the requestor to understand the purpose of the certificate. Further, it should be understood that the OU identifier parameter is a unique identification of an entity to which the certificate is mapped (such as the issuer 116).

In an embodiment, the server system 102 determines whether the certificate associated with the ACS 118 is valid or invalid. If the certificate is valid, the server system 102 may respond with the update certificate request message to inform the ACS 118 that the certificate is invalid.

In another example, the server system 102 may set the ‘action’ field with a ‘renew’ flag to request the ACS 118 to renew or update the certificates associated with it. Alternatively, the server system 102 may set the ‘action’ field with a ‘cancel’ flag to request the ACS 118 to cancel the existing certificates and renew them.

An example pseudo-code for the XML script for a decrypted update certificate request message is given below:

{
Certificate ID:
Message reference ID: 21460000000046998903
OU:
CN:
Expiry date:
Action: Renew/Cancel
}

At 304, the ACS 118 sends an update certificate acknowledgement message to the server system 102. In an embodiment, the ACS 118 transmits an update certificate response message (i.e., update certificate acknowledgement message) to the server system 102. In an example, the update certificate acknowledgement message may include at least a certificate identifier (certificate ID), the message reference ID, a common name (CN), organization unit (OU) identifier, expiry date (such as, certificate expiry date), action flag, etc., among other suitable parameters.

In an embodiment, upon receiving the update certificate request message, the ACS 118 confirms whether the certificate associated with it is valid or invalid. If the certificate is valid, the ACS 118 may respond with the update certificate acknowledgement message to inform the server system 102 that the update certificate request message is invalid. In an example, the ACS 118 may set the ‘action’ field with an ‘invalid’ flag. Alternatively, if the certificate is invalid, the ACS 118 may respond with the update certificate acknowledgement message to inform the server system 102 that the update certificate request message is valid. In an example, the ACS 118 may set the ‘action’ field with a ‘valid’ flag.

An example pseudo-code for the XML script for a decrypted update certificate acknowledgement message is given below:

{
Certificate ID:
Message reference ID: 21460000000046998903
OU:
CN:
Expiry date:
Action: Valid/Invalid
}

At 306, the ACS 118 generates an updated certificate. In an embodiment, the ACS 118 may generate a general certificate signing request and share the request with a local certificate authority to generate the updated certificate. It should be understood that the certificate authority (CA) is a trusted organization that issues digital certificates for the ACS 118 and other entities within the 3DS payment network. In one non-limiting example, the CA is a trusted third-party organization.

At 308, the ACS 118 sends the updated certificate to the server system 102. In an embodiment, upon generation of the updated certificate, the ACS 118 sends the updated certificate with the server system 102 to authenticate itself. For example, this process is similar to sharing the certificate details during the new ACS initialization process.

At 310, the server system 102 authenticates the validity of the updated certificate. In an embodiment, the server system 102 performs verification of the received updated certificate associated with the ACS 118 using standard protocols.

At 312, the server system 102 updates the one or more certificate attributes with the one or more new certificate attributes. In an embodiment, upon successful verification of the updated certificate, the server system 102 updates the previously stored certificate attributes with the updated certificate attributes.

At 314, the server system 102 sends key updated certificate attributes to the MPI server 122. The server system 102 at first determines the key certificate attributes from the one or more updated certificate attributes. Further, the server system 102 sends the key certificate attributes with the MPI server 122. In a non-limiting example, the key certificate attributes may include at least a certificate identifier, a certificate validity period, an ACS identifier (such as acctID), etc., among other suitable attributes.

At 316, the MPI server 122 updates the certificate attributes.

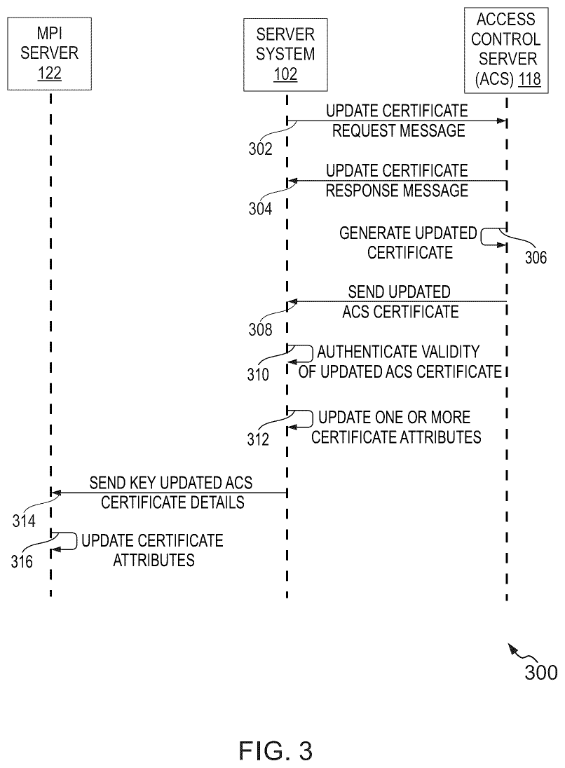

FIG. 4 represents a flow chart for determining the validity of a certificate while performing a transaction in a network, in accordance with an embodiment of the present disclosure. The sequence of operations of the flow chart 400 may not be necessarily executed in the same order as they are presented. Further, one or more operations may be grouped together and performed in the form of a single step, or one operation may have several sub-steps that may be performed in parallel or in a sequential manner. It is to be noted that to explain the flow chart 400, references may be made to elements described in FIG. 1.

The flow chart 400 explains the process of transaction flow for determining the validity of a certificate while performing transaction in a network such as a payment transaction in a 3DS payment network.

At 402, the server system 102 receives check certificate request message from plug-in server such as MPI server 122. In an example, upon dropping the payment transaction due to an invalid certificate, the MPI server 122 generates the check certificate message. In an example, the check certificate message may include at least a message reference identifier, i.e., message ID. It should be understood that the message ID is a unique identifier that remains the same for a given payment transaction. The message ID is generally located within the XML header of the 3DS XML script. It should be understood that since the message ID remains identical during the payment process, therefore any entity in the payment network 110 can identify a payment transaction using its message ID. In various non-limiting examples, the check certificate message may further include other parameters such as certificate identifier (i.e., certificate ID), an OU identifier among other suitable parameters.

An example pseudo-code for the XML script for a decrypted check certificate request message is given below:

{
Certificate ID:
Message reference ID: 21460000000046998903
OU:
}

At 404, the server system 102 determines the authentication server (such as ACS 118) and transaction data associated with the relevant transaction (such as payment transaction). In an example, upon receiving the check certificate message, the server system 102 may locate information related to the relevant payment transaction and the ACS 118 used for authenticating the cardholder 104 during the relevant payment transaction from a database (such as database 114) associated with the server system 102.

In one example, the server system 102 relies on the message ID included in the check certificate message, to determine the relevant payment transaction and the ACS 118. It should be understood that when a new ACS is initialized by the issuer, all relevant details regarding the new ACS are shared with the directory server (i.e., the server system 102). In non-limiting examples, these relevant details may be stored in lists or arrays by the server system 102 in an internal or external database. Further, in an example, the relevant details may include at least one or more certificate attributes of the certificate associated with the new ACS such as but not limited to a certificate identifier, a certificate validity period, a certificate version, certificate issuer information, etc., among other suitable details.

At 406, the server system 102 accesses one or more certificate attributes of the certificate associated with the authentication server (such as ACS 118). In an example, the server system 102 accesses the one or more certificate attributes of the certificate associated with the ACS 118 based on the message ID by performing a lookup operation in the database.

At 408, the server system 102 checks whether the certificate is invalid. In an example, the server system 102 may utilize the certificate validity period attribute from the one or more certificate attributes for determining whether the certificate is valid or invalid/expired. It should be understood that if the certificate validity is expired, the certificate is deemed to be invalid and alternatively, if the certificate validity has not expired, the certificate is deemed to be valid by the server system 102. If the server system 102 determines that the certificate is invalid, the flow proceeds to step 410, otherwise the flow proceeds to step 414.

At 410, the server system 102 transmits check certificate response message to the plug-in server (such as MPI server 122). In various non-limiting examples, the check certificate response message may further include other parameters such as certificate identifier (i.e., certificate ID), an OU identifier, a result field, etc., among other suitable parameters.

It should be noted that the server system 102 sets the ‘result field’ with an ‘invalid’ flag since the certificate associated with the ACS 118 is determined to be valid. In an example, the check certificate response message may inform the MPI 122 that the certificate associated with the ACS 118 is valid. Therefore, this message is used to inform the MPI server 122 that its detection is incorrect.

An example pseudo-code for the XML script for a decrypted check certificate response message when the certificate associated with the ACS 118 is valid is given below:

{
Certificate ID:
Message reference ID: 21460000000046998903
OU:
Result: Invalid
}

At 412, the server system 102 transmits update certificate request message to the authentication server (such as ACS 118). In an example, the update certificate request message informs the ACS 118 that the certificate associated with it has expired. In an example, the update certificate request message may include at least a certificate identifier (certificate ID), the message reference ID, a CN, OU identifier, expiry date (such as, certificate expiry date), action flag, etc., among other suitable parameters. It should be understood that upon learning that its certificate has expired, the ACS 118 may promptly proceed to renew or reissue its certificates thereby reducing ACS 118 downtime and financial losses.

At 414, the server system 102 transmits check certificate response message to the plug-in server (such as MPI server 122). It should be noted that the server system 102 sets the ‘result field’ with a ‘valid’ flag since the certificate associated with the ACS 118 is determined to be invalid. In an example, the check certificate response message may inform the MPI 122 that the certificate associated with the ACS 118 is indeed invalid. Therefore, this message is used to inform the MPI server 122 that its detection is correct.

An example pseudo-code for the XML script for a decrypted check certificate response message when the certificate associated with the ACS 118 is invalid is given below:

{
Certificate ID:
Message reference ID: 21460000000046998903
OU:
Result: Valid
}

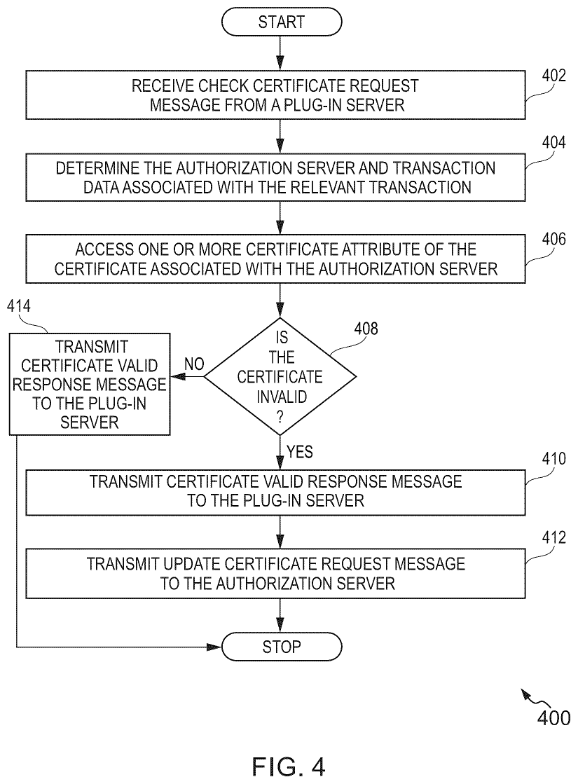

FIG. 5 represents a flow diagram of a computer-implemented method for determining the validity of a certificate while performing a transaction in a network, in accordance with an embodiment of the present disclosure. The method 500 depicted in the flow diagram may be executed by the server system (such as server system 102) which may be a standalone server or a server as a whole incorporated into another server system. In another embodiment, the method 500 depicted in the flow diagram may be executed by the payment server 112 which may be a standalone server or a server as a whole incorporated into another server system. In another embodiment, the server system 102 may be executed by a directory server (not shown for brevity) which may be a standalone server or a server as a whole incorporated into another server system. Operations of the method 500, and combinations of operation in the method 500, may be implemented by, for example, hardware, firmware, a processor, circuitry and/or a different device associated with the execution of software that includes one or more computer program instructions.

In certain implementations, the method 500 may be performed by a single processing thread. Alternatively, the method 500 may be performed by two or more processing threads, each processing thread implementing one or more individual functions, routines, subroutines, or operations of the method. In an illustrative example, the processing threads implementing the method 500 may be synchronized (e.g., using semaphores, critical sections, and/or other thread synchronization mechanisms). Alternatively, the processing threads implementing the method 500 may be executed asynchronously with respect to each other. The method 500 starts at operation 502.

At 502, the method 500 includes receiving, by a server system (such as server system 102), the check certificate request message from the plug-in server upon determining by the plug-in server that a certificate associated with an authentication server during a transaction is invalid. In a non-limiting example, the plug-in server may be the MPI server 122 and the authentication server may be the ACS 118. In an embodiment, the check certificate request message includes at least a message reference identifier.

At 504, the method 500 includes accessing, by the server system 102, one or more certificate attributes of the certificate associated with the authentication server based, at least in part, on the message reference identifier.

At 506, the method 500 includes determining, by the server system 102, validity of the certificate associated with the authentication server based, at least in part, on the one or more certificate attributes.

At 508, the method 500 includes transmitting, by the server system 102, the update certificate request message to the authentication server based, at least in part, on determining that the certificate associated with the authentication server is invalid.

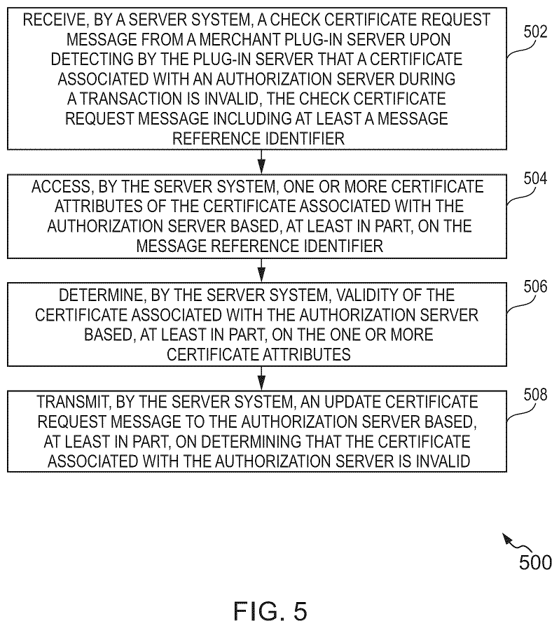

Referring now to FIG. 6, a simplified block diagram of a server system 600 is shown, in accordance with an embodiment of the present disclosure. The server system 600 is similar to the server system 102. In some embodiments, the server system 600 is embodied as a cloud-based and/or SaaS-based (software as a service) architecture.

In one embodiment, the server system 600 includes a computer system 602 and a database 604. The computer system 602 includes at least one processor 606 for executing instructions, a memory 608, and a communication interface 610. The one or more components of the computer system 602 communicate with each other via a bus 612.

In some embodiments, the database 604 is integrated within computer system 602. For example, the computer system 602 may include one or more hard disk drives as the database 604. A storage interface 614 is any component capable of providing the processor 606 with access to the database 604. The storage interface 614 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 606 with access to the database 604. In one embodiment, the database 604 is configured to store consent tokens of users and encrypted payment credential data associated with the consent tokens.

The processor 606 includes suitable logic, circuitry, and/or interfaces to execute computer-readable instructions for managing and sharing user consent among multiple applications installed on a user device. Examples of the processor 606 include, but are not limited to, an application-specific integrated circuit (ASIC) processor, a reduced instruction set computing (RISC) processor, a complex instruction set computing (CISC) processor, a graphical processing unit (GPU) processor, a field-programmable gate array (FPGA), and the like. The memory 608 includes suitable logic, circuitry, and/or interfaces to store a set of computer-readable instructions for performing operations. Examples of the memory 608 include a random-access memory (RAM), a read-only memory (ROM), a removable storage drive, a hard disk drive (HDD), and the like. It will be apparent to a person skilled in the art that the scope of the disclosure is not limited to realizing the memory 608 in the server system 600, as described herein. In another embodiment, the memory 608 may be realized in the form of a database server or a cloud storage working in conjunction with the server system 600, without departing from the scope of the present disclosure.

The processor 606 is operatively coupled to the communication interface 610 such that the processor 606 is capable of communicating with a remote device 616, or communicating with any entity connected to the network 124 (as shown in FIG. 1). It is noted that the server system 600 as illustrated and hereinafter described is merely illustrative of an apparatus that could benefit from embodiments of the present disclosure and, therefore, should not be taken to limit the scope of the present disclosure. It is noted that the server system 600 may include fewer or more components than those depicted in FIG. 6.

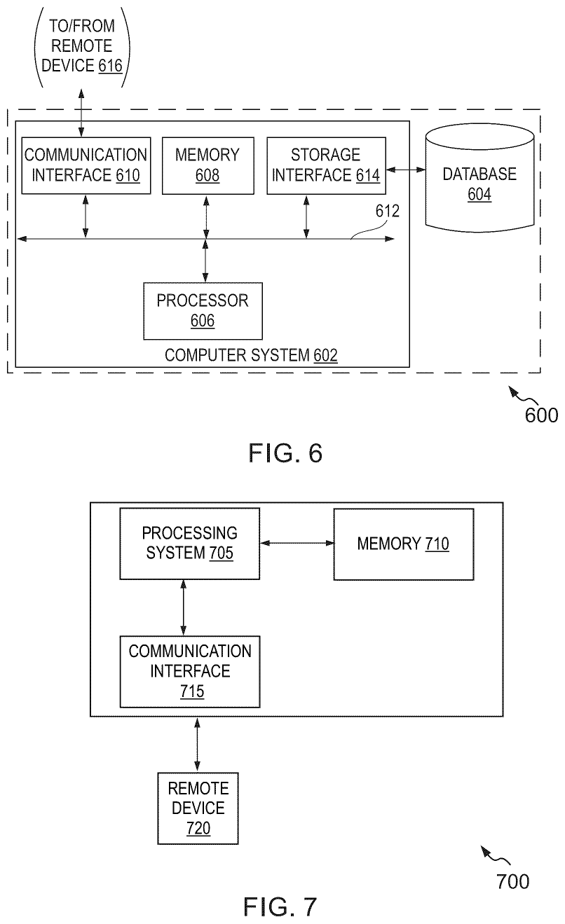

FIG. 7 is a simplified block diagram of a payment server 700, in accordance with an embodiment of the present disclosure. The payment server 700 is an example of the payment server 112 of FIG. 1. A payment network may be used by the payment server 700 as a payment interchange network. Examples of payment interchange network include, but are not limited to, Mastercard® payment system interchange network. The payment server 700 includes a processing system 705 configured to extract programming instructions from a memory 710 to provide various features of the present disclosure. Further, two or more components may be embodied in one single component, and/or one component may be configured using multiple sub-components to achieve the desired functionalities. Some components of the payment server 700 may be configured using hardware elements, software elements, firmware elements and/or a combination thereof. In one embodiment, the payment server 700 is configured to determine authenticity of the payment card based on the card image and send a payment transaction request to the issuer server 116 via the acquirer server 120 and the payment network 110.

Via a communication interface 715, the processing system 705 receives a payment authorization request from a remote device 720 such as the server system 102, the acquirer server 120, or administrators managing server activities. The payment server 700 may also perform similar operations as performed by the server system 102. For the sake of brevity, the detailed explanation of the payment server 700 is omitted herein with reference to FIG. 6.

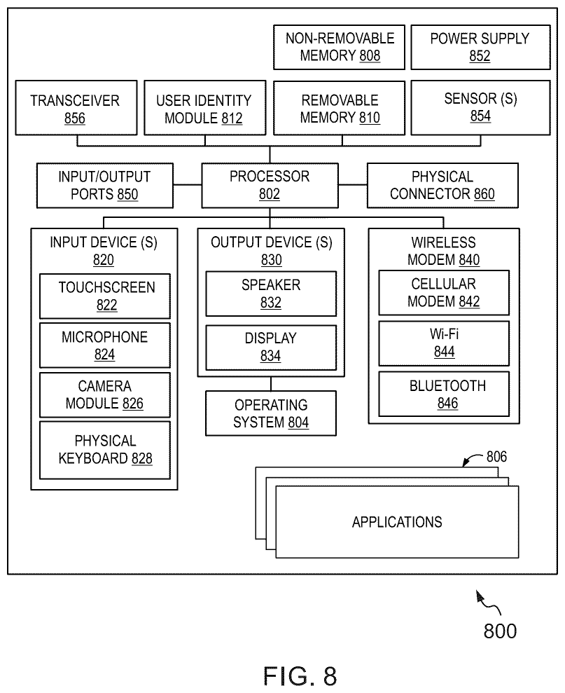

FIG. 8 is a simplified block diagram of a user device 800 for example a mobile phone or a desktop computer capable of implementing the various embodiments of the present disclosure. For example, the user device 800 may correspond to the user device 106 of FIG. 1. In one embodiment, for example, the user device 800 may correspond to the user device 106 of FIG. 1. The user device 800 is depicted to include one or more applications such as the applications 806. In one embodiment, the applications 806 include the first application and the second application. In another embodiment, the applications 806 include the first merchant application and the second merchant application. The applications 806 can be an instance of an application downloaded from a third-party server or a merchant server. In an embodiment, the applications 806 are capable of communicating with the server system 102 for facilitating transaction processing. In another embodiment, the applications 806 are capable of communicating with the server system 102 for facilitating payment transaction processing.

It should be understood that the user device 800 as illustrated and hereinafter described is merely illustrative of one type of device and should not be taken to limit the scope of the embodiments. As such, it should be appreciated that at least some of the components described below in connection with that the user device 800 may be optional and thus in an embodiment may include more, less or different components than those described in connection with the embodiment of the FIG. 8. As such, among other examples, the user device 800 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the user device 800 and support for one or more payment application programs (see, applications 806) such as the payment gateway application and merchant applications, that implement one or more of the innovative features described herein. In addition, applications 806 may include common mobile computing applications (e.g., telephony applications, email applications, calendars, contact managers, web browsers, and messaging applications) or any other computing application.

The illustrated user device 800 includes one or more memory components, for example, a non-removable memory 808 and/or removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and applications 806. The user device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA11000, wideband CDMA (WCDMA) and time division-synchronous CDMA (TD-SCDMA), or with fourth-generation (4G) wireless communication protocols such as LTE (Long-Term Evolution).

The user device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to, a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the user device 800 and a public switched telephone network (PSTN).

The user device 800 can further include one or more input/output ports 850, a power supply 852, one or more sensors 854 for example, an accelerometer, a gyroscope, a compass, or an infrared proximity sensor for detecting the orientation or motion of the user device 800 and biometric sensors for scanning biometric identity of an authorized user, a transceiver 856 (for wirelessly transmitting analog or digital signals) and/or a physical connector 860, which can be a USB port, IEEE 894 (FireWire) port, and/or RS-232 port. The illustrated components are not required or all-inclusive, as any of the components shown can be deleted and other components can be added.

The disclosed methods with reference to FIG. 5, or one or more operations of the server system 102 may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal-oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 102 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAYED Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

We claim:

1. A computer-implemented method, comprising:
receiving, by a server system, a check certificate request message from a plug-in server upon detecting by the plug-in server that a certificate associated with an authentication server during a transaction is invalid, the check certificate request message comprising at least a message reference identifier;
accessing, by the server system, one or more certificate attributes of the certificate associated with the authentication server based, at least in part, on the message reference identifier;
determining, by the server system, validity of the certificate associated with the authentication server based, at least in part, on the one or more certificate attributes; and
transmitting, by the server system, an update certificate request message to the authentication server based, at least in part, on determining that the certificate associated with the authentication server is invalid.

2. The computer-implemented method of claim 1, wherein the plug-in server is a merchant plug-in (MPI) server, the server system is a directory server (DS), the authentication server is an access control server (ACS), the MPI server, the DS, and the ACS being part of a payment network and the transaction being a payment transaction.

3. The computer-implemented method of claim 1, wherein the one or more certificate attributes comprise at least a certificate identifier, a certificate validity period, a certificate version, and certificate issuer information.

4. The computer-implemented method of claim 3, wherein determining the validity of the certificate associated with the authentication server, further comprises:
determining, by the server system, if the certificate validity period associated with the certificate has expired based at least on the certificate validity period.

5. The computer-implemented method of claim 1, further comprising:
transmitting, by the server system, a check certificate response message to the plug-in server, wherein the check certificate response message comprises one of:
a valid flag in a result field based, at least in part, on determining that the certificate associated with the authentication server is invalid; and
an invalid flag in the result field based, at least in part, on determining that the certificate associated with the authentication server is valid.

6. The computer-implemented method of claim 1, further comprising:
receiving, by the server system, an update certificate acknowledgment message from the authentication server in response to the update certificate request message.

7. The computer-implemented method of claim 1, further comprising:
transmitting, by the server system, an update authentication server certificate advice message to an issuer server associated with the authentication server; and
receiving, by the server system, an acknowledgment message from the issuer server.

8. The computer-implemented method of claim 1, further comprising:
receiving, by the server system, an updated authentication server certificate from the authentication server, the updated authentication server certificate comprising one or more new certificate attributes; and
updating, by the server system, the one or more certificate attributes with the one or more new certificate attributes.

9. The computer-implemented method of claim 1, wherein the certificate associated with the authentication server is an extensible markup language (XML) certificate.

10. A server system comprising:
at least one processor;
memory; and
instructions stored on the memory that when executed by the at least one processor direct the server system to perform a method comprising:
receiving, by a server system, a check certificate request message from a plug-in server upon detecting by the plug-in server that a certificate associated with an authentication server during a transaction is invalid, the check certificate request message comprising at least a message reference identifier;
accessing, by the server system, one or more certificate attributes of the certificate associated with the authentication server based, at least in part, on the message reference identifier;
determining, by the server system, validity of the certificate associated with the authentication server based, at least in part, on the one or more certificate attributes; and
transmitting, by the server system, an update certificate request message to the authentication server based, at least in part, on determining that the certificate associated with the authentication server is invalid.

11. The server system of claim 10, wherein the plug-in server is a merchant plug-in (MPI) server, the server system is a directory server (DS), the authentication server is an access control server (ACS), the MPI server, the DS, and the ACS being part of a payment network and the transaction being a payment transaction.

12. The server system of claim 10, wherein the one or more certificate attributes comprise at least a certificate identifier, a certificate validity period, a certificate version, and certificate issuer information.

13. The server system of claim 12, wherein determining the validity of the certificate associated with the authentication server, further comprises:
determining, by the server system, if the certificate validity period associated with the certificate has expired based at least on the certificate validity period.

14. The server system of claim 10, further comprising instructions that direct the server system to perform the method further comprising:
transmitting, by the server system, a check certificate response message to the plug-in server, wherein the check certificate response message comprises one of:
a valid flag in a result field based, at least in part, on determining that the certificate associated with the authentication server is invalid; and
an invalid flag in the result field based, at least in part, on determining that the certificate associated with the authentication server is valid.

15. The server system of claim 10, further comprising instructions that direct the server system to perform the method further comprising:
receiving, by the server system, an update certificate acknowledgment message from the authentication server in response to the update certificate request message.

16. The server system of claim 10, further comprising instructions that direct the server system to perform the method further comprising:
transmitting, by the server system, an update authentication server certificate advice message to an issuer server associated with the authentication server; and
receiving, by the server system, an acknowledgment message from the issuer server.

17. The server system of claim 10, further comprising instructions that direct the server system to perform the method further comprising:
receiving, by the server system, an updated authentication server certificate from the authentication server, the updated authentication server certificate comprising one or more new certificate attributes; and
updating, by the server system, the one or more certificate attributes with the one or more new certificate attributes.

18. The server system of claim 10, wherein the certificate associated with the authentication server is an extensible markup language (XML) certificate.
